(19) United States
(12) Patent Application Publication
(10) Pub. No.: US 2024/0246865 A1
(43) Pub. Date: Jul. 25, 2024

(54) FLOWABLE FIBER COMPOSITE MATERIALS AND METHODS OF MAKING AND USING THE SAME

(71) Applicant: Lawrence Livemore National Security, LLC, Livermore, CA (US)

(72) Inventors: Gabriella Corrinna Susanna King, Livermore, CA (US); Wyatt L. Du Frane, Livermore, CA (US); Isabel Robin Crystal, Livermore, CA (US); James Timothy Cahill, Livermore, CA (US)

(21) Appl. No.: 18/421,843

(22) Filed: Jan. 24, 2024

Related U.S. Application Data
(60) Provisional application No. 63/441,161, filed on Jan. 25, 2023.

(51) Int. Cl. C04B 35/80; C04B 35/626; C04B 35/628; C04B 35/634; C04B 35/638

(52) U.S. Cl. CPC C04B 35/80; C04B 35/62635; C04B 35/62655; C04B 35/62857; C04B 35/62886; C04B 35/62892; C04B 35/63416; C04B 35/638; C04B 2235/3813; C04B 2235/524; C04B 2235/5244; C04B 2235/5248; C04B 2235/5436

(57) ABSTRACT

Flowable fiber composite materials that include at least one fiber component and at least one powder component that form composite particles. Methods of making the fiber composite materials include forming and mixing a suspension and spray drying the suspension to form particles.

### RELATED APPLICATIONS

This application claims priority to U.S. Provisional Patent Appl. No. 63/441,161, filed Jan. 25, 2023, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to composite materials, and more particularly to flowable fiber composite materials, and methods of making and using the same.

### BACKGROUND

Nanomaterials (such as nanoparticles, nanopowders, nanoplatelets, nanofibers) are used in a wide variety of applications as they often provide desirable characteristics compared to their macroparticle counterparts. Ceramic and metal materials are no exception, and nanograined structures often display increased strength and other enhanced properties. Nanomaterials are challenging to work with due to the poor packing density and tendency to form agglomerations, which makes it difficult to form a homogenous composite when incorporated. These materials typically display poor flowability due to the interparticle forces that dominate at small length scales coupled with irregularity in the particle shape thereby making them difficult to load into dies, flow through equipment, or spread onto surfaces.

The continued development of manufacturing techniques for structures utilizing materials such as ultra-high temperature ceramic (UHTC) nanomaterials is necessary for advancements in many different applications. For example, applications of ultra-high temperature ceramics are often found in the fields of energy production, transportation, and aerospace; and often include applications that provide thermal stability and protection for components and/or surfaces. Because of their high strength and capability to withstand extreme environments, UHTCs are an ideal material for applications in which components are exposed to extreme environments and temperatures, such as environments that have temperatures that reach above 1000° C. UHTCs also exhibit high melting temperatures, high hardness, thermal shock resistance, and good chemical and thermal stability. Their application has often been limited by issues in integrating UHTCs in systems because of the special manufacturing requirements for processing UHTC feedstock.

Additionally, while there have been many attempts to incorporate fiber reinforcement into various structures, there has been relatively little effort incorporating ceramic fibers in ceramic powder-based bulk material, and especially incorporating ceramic nanofibers in UHTC bulk materials. Moreover, methods of incorporation typically rely on ball milling, which can result in excessive breakage of the fibers. In some efforts, nanofibers have been investigated for wound care dressings that utilize bulk materials such as hydrogels.

It would be desirable to create a material that combines the flowability of microspheres with the thermal and mechanical benefits of fibers while achieving homogeneity with little fiber breakage.

### SUMMARY

Flowable fiber composite materials, and methods for making and using flowable fiber composite materials, are described. A fiber composite material includes a fiber component and a powder component.

A flowable fiber composite material, in accordance with one aspect of the present invention, includes a plurality of particles. Each particle is a composite of at least one fiber component and at least one powder component.

In some approaches, the particles have a core-shell configuration with the fiber component forming the core and the powder component forming the shell.

A method of making a flowable fiber composite material includes forming a suspension comprising at least one fiber component, at least one powder component, and a solvent, mixing the suspension for dispersing the at least one fiber component throughout the suspension, spray drying the suspension to form a plurality of particles, and heat treating the plurality of particles.

A method of using a flowable fiber composite material includes preparing a flowable fiber composite material, and forming a part or coating, using the flowable fiber composite material. The flowable fiber composite material includes a plurality of particles having at least one fiber component and at least one particle component. The particles have a core-shell configuration with the fiber component forming the core and the particle component forming the shell.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as preferred modes of use, reference should be made to the following detailed description read in conjunction with the accompanying drawings.

FIG. 1 is a schematic drawing of a fiber composite particle, in accordance with one aspect of the present invention.

FIGS. 2A and 2B are scanning electron microscope (SEM) images of fibers that can be used in flowable fiber composite materials, in accordance with various aspects of the present invention.

FIG. 3 is an SEM image of a consolidated part of silicon carbide (SiC) fibers and zirconium diboride (ZrB₂) powder prepared via resonant acoustic mixing and spark plasma sintering, in accordance with one aspect of the present invention.

FIG. 4 is an SEM image of SiC fiber material after a dispersion method was applied, in accordance with one aspect of the present invention.

FIGS. 5A and 5B illustrate a method of making a flowable fiber composite material, with FIG. 5A being a schematic illustration of the method and FIG. 5B being a flowchart showing the method of making a flowable fiber composite material, in accordance with one aspect of the present invention.

FIG. 6 is a flowchart showing a method of using a flowable fiber composite material, in accordance with one aspect of the present invention.

FIGS. 7A and 7B are SEM images of a spray dried composite material including SiC fibers and ZrB₂ powder at different magnifications, in accordance with one aspect of the present invention.

FIGS. 8A and 8B are SEM images of a spray dried composite material including carbon fibers and ZrB₂ powder at different magnifications, in accordance with one aspect of the present invention.

FIGS. 9A and 9B are SEM images of spray dried materials comparing ZrB₂ powder without fibers, and with silicon nitride (Si₃N₄) fibers, in accordance with various aspects of the present invention.

FIGS. 10A-10C are SEM images of spray dried composite materials including Si₃N₄ fibers and ZrB₂ powder, in accordance with various aspects of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. The term “about” as used herein indicates the value preceded by the term “about,” along with any values reasonably close to the value preceded by the term “about,” as would be understood by one of skill in the art. When not indicated otherwise, the term “about” denotes the value preceded by the term “about” ±10% of the value. For example, “about 10” indicates all values from and including 9.0 to 11.0.

A list of acronyms used in the description is provided below.
3D three-dimensional
C Celsius
CF carbon fibers
CNF carbon nanofibers
DI deionized (e.g., deionized water)
μm micron or micrometer
nm nanometer
PEI polyethylenimine
PVA poly(vinyl alcohol)
SEM scanning electron microscopy
SiC silicon carbide
Si₃N₄ silicon nitride
TBC thermal barrier coating
UHTC ultra-high temperature ceramic
wt % weight percent
vol % volume percent
ZrB₂ zirconium diboride

The following description discloses several compositions of flowable fiber composite materials and methods of making and using flowable fiber composite materials. The flowable fiber composite materials generally spray dried droplets, or particles, that comprise both a fiber material (also referred to herein as a fiber, fiber component, etc.) and a powder material (also referred to herein as a powder, powder component, etc.). Preferably, the particles are generally uniform in terms of composition, relative ratios of fiber to powder, and/or particle size distribution. The uniform particles of the fiber composite materials exhibit enhanced flowability of the material to provide a fiber reinforced composite material that can be used to improve the thermal and mechanical performance of structures and coatings formed from the materials, such as high temperature composite thermal barrier coatings for gas turbine blades and aerospace applications.

The fiber composite materials may be formed from microsphere particles that have configurations that allow them to be flowable. That flowability allows the materials to be utilized as powder feedstock for a variety of manufacturing methods including plasma spray, spark plasma sintering, hot pressing, additive manufacturing methods such as direct ink writing, powder bed fusion methods, injection molding, extrusion, slip casting, gel casting, tape casting, etc.

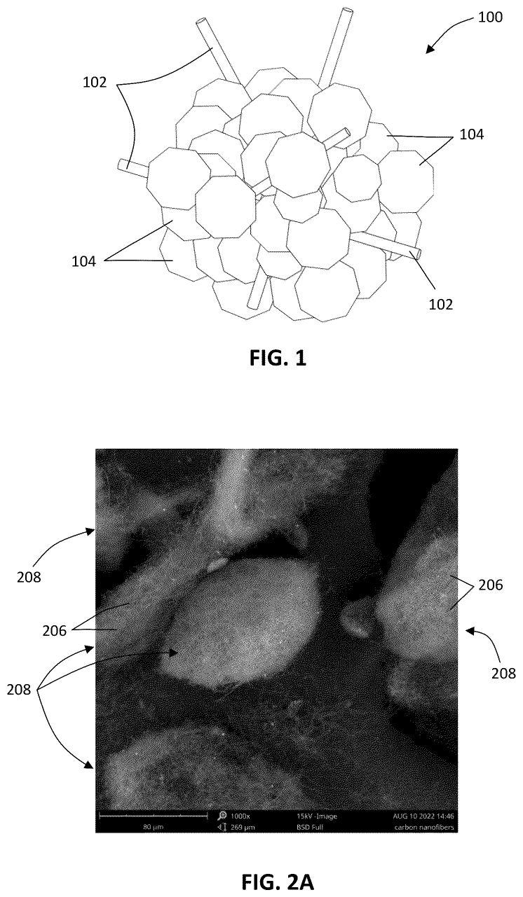

Referring to FIG. 1, a flowable fiber composite material, in accordance with one approach, includes a plurality of particles 100. The particles 100 are constructed from a plurality of materials that include a fiber component 102 and a powder component 104.

In preferred aspects, the particles 100 generally have a core-shell configuration with the fiber component 102 being considered as the core and the powder component 104 being considered as the shell. The fibers that constitute the fibers component 102 are predominantly within the particle surrounded by the powder component 104, e.g., most of the volume of the fiber component is within the overall outer periphery of the particle and is surrounded by the powder component.

Note that particles with some portion of the fiber component 102 protruding therefrom, as shown in FIG. 1, are considered particles having a core-shell configuration, so long as most of the volume of the fiber component is within the overall outer periphery of the particle and is surrounded by the powder component.

The particles 100 may be formed using techniques and methods disclosed herein that result in the flowable fiber composite being formed of particles having particle sizes that provide a desired flowability of the composite material. In an example, the particle 100 can define a major dimension, such as an equivalent size diameter as measured according to a conventional technique, maximum cross-sectional dimension, etc. that defines the particle size. Exemplary techniques to measure equivalent size diameter include known: optical particle sizing methods, sieving, laser diffraction methods, and dynamic light scattering methods.

In at least some approaches, a majority, and preferably all, of the particles have equivalent size diameters, as measured according to a conventional technique, that are on micron scale (1-1000 μm). In some approaches, the particles in a particular fiber composite material have an average equivalent size diameter of less than about 100 μm. In some approaches, a majority of the particles have a major dimension that is in a range of about 15 μm-100 μm. In some approaches, a majority of the particles have a major dimension that is in a range of about 25 μm-35 μm. In some approaches, a majority of the particles have a major dimension of about 30 μm.

As will be described in greater detail below with regard to methods of making the fiber composite material, during at least a portion of a method of making the flowable fiber composite material, the material can include additional components. For example, a mixture used to form the particles 100 can include one or more binders. Still further, during at least a portion of the method of making the flowable fiber composite material, a mixture (suspension) used to form the particles 100 can include one or more dispersants.

As noted above, the particles 100 are generally constructed from at least one fiber component 102. The fiber component 102 may be of singular composition, or may include a combination of fibers having differing compositions. Moreover, the fiber component may be organic, inorganic, or may be a combination of organic and inorganic fibers. For example, commercially available chopped ceramic fibers may be used in some approaches. In exemplary approaches, the fiber component 102 is selected from carbon fibers (CF) such as carbon nanofibers (CNF), silicon carbide (SiC) fibers, and/or silicon nitride (Si₃N₄) fibers.

In some approaches, the average longitudinal length of the fiber component is less than about 1000 μm, though other approaches may use a fiber component having an average fiber length that is greater than 1000 μm. Care should be taken, when longer length fibers are desired, to select a length that does not block up the extrusion nozzle used to form the particles. Preferably, the average longitudinal length of the fiber component is greater than 0.05 μm. In some approaches, the average longitudinal length of the fibers is in a range of about 15 μm-500 μm. In other approaches, the average longitudinal length of the fibers is in a range of about 0.05 μm-50 μm. In further approaches, the average longitudinal length of the fibers is in a range of about 1 μm-300 μm. In some approaches, the fibers have an average longitudinal length in a range of about 25 μm to about 35 μm.

The average diameter of the fiber component 102 is preferably less than about 2000 nm, more preferably less than about 1000 nm, and even more preferably less than about 400 nm. In some approaches, the average diameter of the fiber component 102 is about less than about 200 nm, and more preferably about 100 nm or less. For example, the average diameter may be in a range of about 1 nm-50 nm.

It has surprisingly been found that the use of micron scale particle components 104 (average particle size in the range of 1 μm-1000 μm) with nano scale fiber components 102 (average length and diameter less than 1000 nm) to form composite particles results in said composite particles exhibiting greatly enhanced flowability that is far above similarly-sized materials currently in existence. Accordingly, preferred approaches have components in these ranges.

In one exemplary approach, the fiber component 102 includes carbon nanofibers having an average diameter of about 100 nm and an average longitudinal length in a range of about 20 μm-200 μm. In another example, the fiber component 102 includes SiC fibers, such as SiC whiskers having an average diameter of about 1.5 μm and an average longitudinal length of about 18 μm. In a still further example, the fiber component 102 may include Si₃N₄ fibers having an average diameter of about 0.1 μm and an average longitudinal length of about 0.8 μm. In at least some approaches, the average length of the fibers is selected to approximate the desired particle size of particles 100 that provide a desired flowability. It should be appreciated that other materials of particular average sizes can be selected for the fiber component 102 that provide about a predetermined strength, size, and/or temperature survivability.

The particles 100 are also generally constructed from at least one powder component 104. The powder component 104 may include any suitable material or combination of materials that would become apparent to one skilled in the art after reading the present disclosure. For example, in some approaches, the powder component can be selected from a variety of ceramic materials. Examples of ceramic materials that can be used include, but are not limited to, various borides, carbides, nitrides, and oxides. Examples of suitable borides include zirconium diboride, hafnium diboride, titanium diboride, tantalum diboride, and niobium diboride. Examples of suitable carbides include boron carbide, silicon carbide, tungsten carbide, zirconium carbide, hafnium carbide. Examples of suitable nitrides include silicon nitride, aluminum nitride, boron nitride. Examples of suitable oxides include alumina, yttria, zirconia, mullite. In some approaches, a first component is constructed from a ceramic material that is selected from the group consisting of boron carbide (B₄C), zirconium diboride (ZrB₂), Zirconium carbide (ZrC), hafnium carbide (HfC), and hafnium diboride (HfB₂), and yttrium aluminium garnet (YAG, Y₃Al₅O₁₂).

The average powder size of the powder component 104 is preferably in a range of about 10 nm-100 μm, in some approaches 0.1 μm-10 μm, more preferably in a range of about 0.5 μm-10 μm. The average powder size may be determined according to labeling on a package, sieve analysis, use of a particle size analyzer, etc.

In one exemplary approach, the powder component 104 is a ZrB₂ powder. For example, the powder component 104 may be a ZrB₂ powder having an average size of about 5 μm.

The fiber component 102 and/or powder component 104 may be manufactured or purchased. For example, the fiber component 102 and/or powder component 104 may include in-house processed fibers and/or powders, respectively, e.g., fibers and/or powders fabricated via any suitable technique such as melt spinning, electrospinning, sol-gel chemistry, chemical vapor deposition, etc.

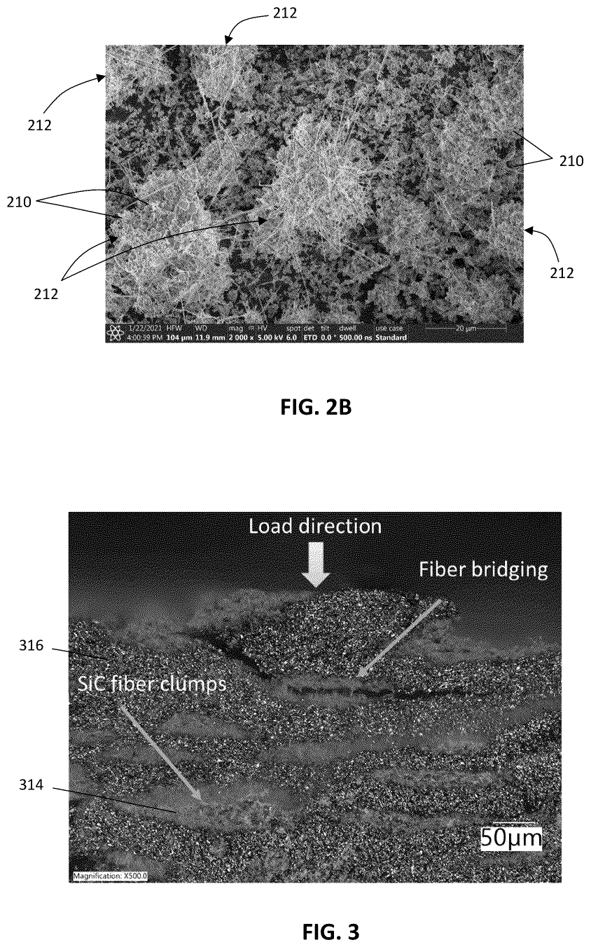

Referring to FIGS. 2A and 2B, examples of fibers that can be included in the fiber composite material are shown in an as-received condition, e.g., as purchased from a commercial source of said fibers. In particular, FIG. 2A illustrates carbon fibers 206 and FIG. 2B illustrates Si₃N₄ fibers 210. Both images demonstrate that the fibers have a natural tendency to form clumps, 208 and 212 respectively, i.e., to naturally form cohesive agglomerates that reduce the flowability and ease of achieving a homogenous mixture. That tendency presents a challenge in creating the flowable fiber composite material described herein because the fibers must be dispersed and mixed with the powder component to form more ordered particles of the fiber composite material.

An example of a mixture of a fiber component and a powder component is illustrated in FIG. 3. The components of the mixture included SiC fibers and ZrB₂ powder. The components were dry mixed using an acoustic mixer, such as a LabRAM acoustic mixer offered by Resodyn Acoustic Mixers, Inc. of Butte, Montana. The image shows the mixture after it was formed into a puck and subjected to thermal cycling, e.g., sintering. As shown in the image, the mixture included relatively large clumps of SiC fibers 314 surrounded by broad volumes of ZrB₂ 316. While the image shows that dry mixing of the components was insufficient to provide an even distribution of SiC fibers among the ZrB₂ material, it does show that the SiC fibers formed fiber bridging in the sample. That bridging can result in improved mechanical properties. Additionally, the sample indicated that the SiC fibers were able to survive sintering of the sample.

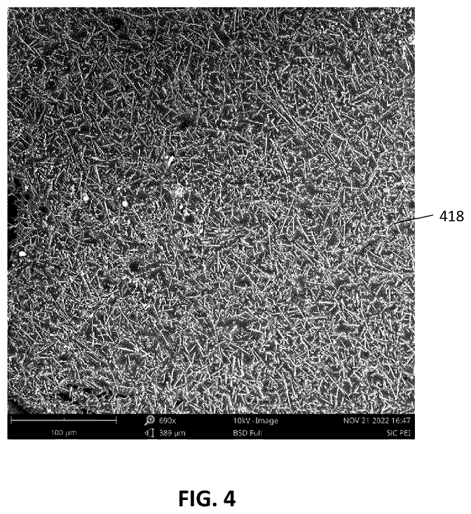

In order to create a flowable fiber composite material, the fibers of the fiber component are ideally dispersed amongst the powder component prior to forming composite particles. For example, fibers forming large clumps should be separated to substantially reduce clumping, and to improve distribution of the fibers. In an exemplary technique, it was determined that an ultrasonic probe could be applied to a mixture of SiC fibers 418, deionized (DI) water, and polyethylenimine (PEI) to break down clumps and distribute the SiC fibers 418 throughout the mixture. As shown in FIG. 4, after application of the ultrasonic probe the SiC fibers 418 became relatively evenly dispersed with minimal clumping of the fibers. Accordingly, use of an ultrasonic probe is a preferred method, but other dispersion techniques that would become apparent to one skilled in the art after reading the present disclosure may be used.

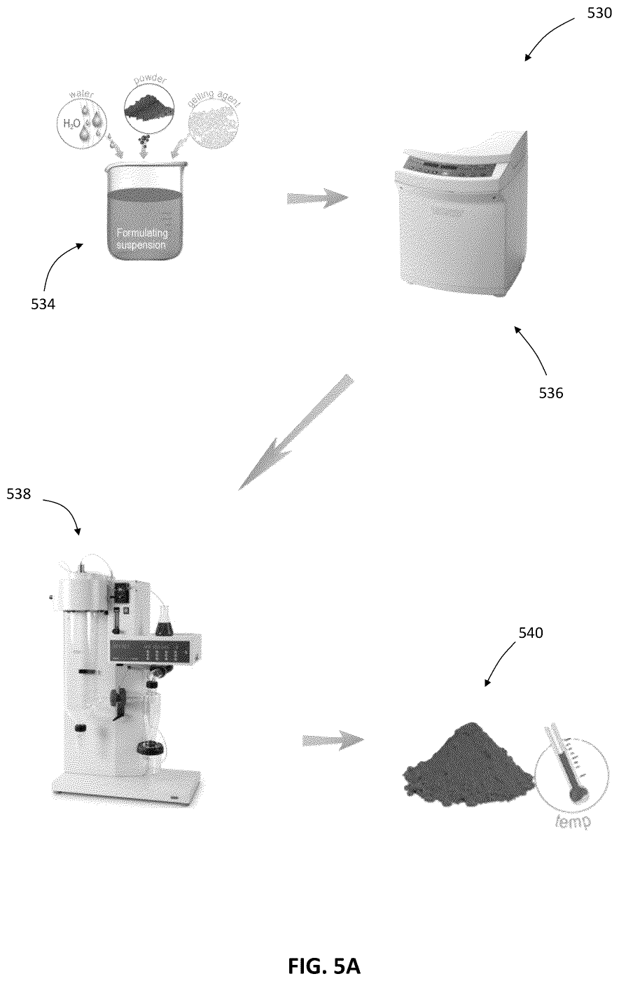

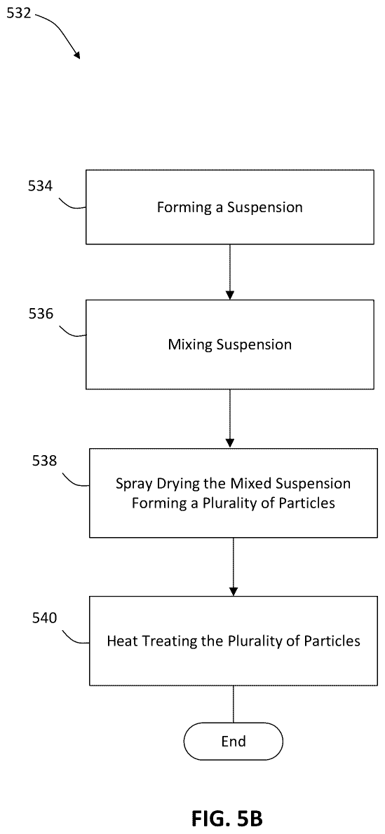

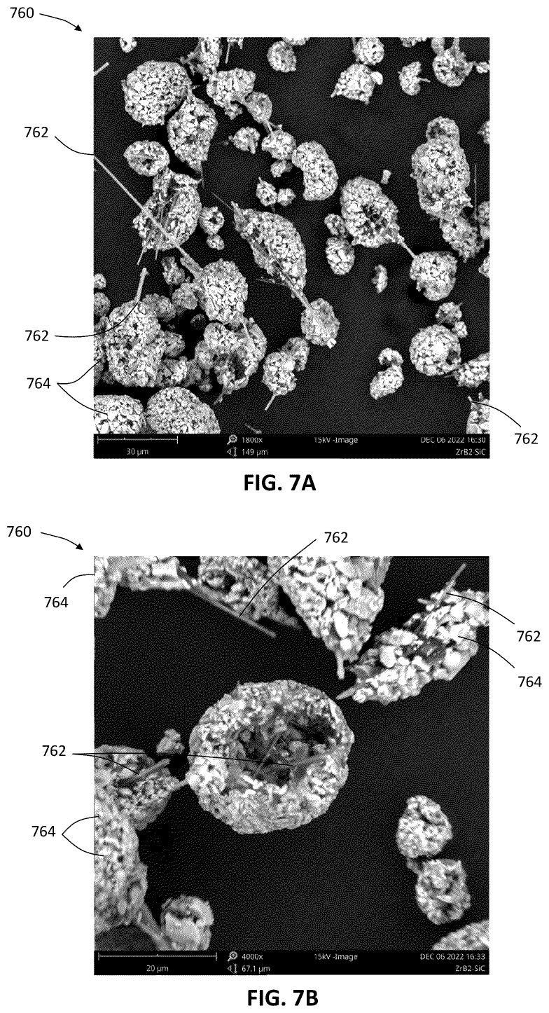

Referring to FIGS. 5A and 5B, an exemplary method of making a flowable fiber composite material is shown. In particular, FIG. 5A illustrates a schematic 530 of the method while FIG. 5B depicts a flowchart 532 of the method. The method can be used to make flowable fiber composite materials such as the flowable fiber composite materials described herein with reference to FIGS. 7-10, among others. Further compositional, structural, and operational aspects will be apparent to persons skilled in the relevant art(s) based on the discussion regarding schematic 530 and flowchart 532.

As shown in FIGS. 5A and 5B, the method begins at step 534. In step 534 a suspension is formed. The suspension, in some approaches, is formed from a combination of a fiber component, a powder component, a binder, and solvent.

The fiber component may be any one or a combination of the fibers listed or suggested elsewhere herein. Examples of a fiber component include Si₃N₄, SiC, carbon fibers and/or combinations thereof. The concentration of the powder component may be selected in dependence upon the material system and desired viscosity of the suspension.

The powder component may be any one or a combination of the powder materials listed or suggested elsewhere herein. In one exemplary approach, the powder component includes 5 μm ZrB₂ nano powder.

The powder component plus fiber component collectively is preferably below about 40 wt % of the suspension, but could be higher in some approaches. For example, the collective wt % of the powder component plus fiber component may be in a range of about 20 wt % to about 40 wt % of the suspension, in some approaches about 28 wt % to about 38 wt %, about 30 wt % to about 35 wt %, etc. The ratio of the fiber component to powder component is dependent upon the materials used, and is preferably in a volumetric ratio of 0.01:10 to 10:1 (fiber:particle). Illustrative fiber:particle volumetric ratios, in accordance with various approaches, include, 0.01:10 to 0.1:10, 0.01:10 to 0.5:1, 0.01:10 to 0.9:1, 0.01:10 to 1:1, 1:10 to 10:1, 5:10 to 10:1, 1:1 to 10:1, and 5:1 to 10:1.

The binder may be any suitable binder usable for conventional spray drying processes. Preferred binders are polymeric and/or organics. In preferred approaches, the binder is one or more of: poly(vinyl alcohol) (PVA), polyethyleneimine (PEI), latex based on a copolymer of styrene and acrylic ester, an epoxy resin of known type, a mixture of resorcinol-formaldehyde mixture, polyethylene glycol (PEG), cellulose, polyvinyl pyrrolidone (PVP), polyacrylate, polyethylene glycol-hydroxyethyl cellulose cobinder, etc. and mixtures thereof. Note that water soluble binders may be preferable where spray drying is used. The binder should be present in an effective amount to hold the fiber component and the particle component in the composite particles together after formation thereof e.g., via spray drying. Preferably, during formation of the composite particles, the nozzle is heated enough to set the binder but not sinter the particles. The binder holds the components of the composite particles together for later use of the composite particles, e.g., to form larger products, layers, coatings, sintered particles, etc.

Additionally, other components can be included in the suspension, such as, for example, one or more dispersants of known type. Any suitable dispersant that would become apparent to one skilled in the art after reading the present disclosure may be used. The dispersant or combination of dispersants should be present in an effective amount to enhance distribution of the fibers throughout the suspension prior to forming the composite particles e.g., via spray drying.

Another additive that may be added to the suspension is a defoaming agent in an effective amount to reduce foam from mixing.

In some approaches, a dispersant may be selected for a particular fiber material so that the fibers can be more evenly distributed throughout the suspension during subsequent mixing. For example, a dispersant may be selected to prevent fibers from floating and/or sinking in the suspension, e.g., by changing the surface chemistry of the fibers. In an example, formulations including carbon fibers may benefit from adding a nonionic surfactant, such as conventional Triton® X, that may be used as a dispersant.

An exemplary solvent is DI water. In other approaches, a suitable organic solvent of known type may be used. Examples of organic solvents include isopropyl alcohol (IPA), methyl ethyl ketone (MEK), etc. The solvent is present in the suspension in an effective amount to enable formation of the composite particles from the slurry.

The effective amounts of the various components of the suspension may be determined by one skilled in the art, after being apprised of the present disclosure, without undue experimentation based on the materials selected for use in the method.

In various examples, the suspension can be formed using the formulations shown in Table 1 below.

TABLE 1
Sample Formulations

| | |
|---|---|
| 1 | 6 vol % (ZrB₂—Si₃N₄), 5 wt % fibers, |
| | 7 wt % PVA to solids |
| 2 | 4 vol % (ZrB₂ + Si₃N₄ fibers), 7.5 wt % fibers, |
| | ~7 wt % PVA to solids |
| 3 | 8.5 vol % (ZrB₂ + Si₃N₄ fibers), 7.5 wt % fibers, |
| | ~7 wt % PVA to solids |
| 4 | 12 vol % (ZrB₂ + Si₃N₄ fibers), 7.5 wt % fibers, |
| | ~7 wt % PVA to solids |
| 5 | 9 vol % (ZrB2—CNF), 10 wt % fibers, |
| | ~7 wt % PVA to solids |
| 6 | 8 vol % (ZrB₂—CNF), 7.5 wt % fibers, 1:1 CNF |
| | to Triton X, ~7 wt % PVA to solids |
| 7 | 9 vol % (ZrB₂—SiC), 7.5 wt % fibers, |
| | ~7 wt % PVA to solids |

The amounts of the components can be varied to provide a desired viscosity of the suspension so that the suspension, after mixing, can be pumped sufficiently into a spray dryer, avoid nozzle clogging, etc. Anything that changes in the suspension might change its viscosity. For example, as the concentration of the fibers increases, the suspension becomes more viscous, and it can become more difficult to pump the suspension through a conduit and into the spray dryer. As a result, a suspension that is above a predetermined viscosity becomes difficult to atomize in the air dryer to form composite particles. Accordingly, the concentration of solvent may be increased to reduce the viscosity.

At step 536, the suspension formed in step 534 is mixed to form a homogeneous suspension. The mixing step generally includes a combination of mixing techniques. During mixing the suspension is assessed qualitatively to determine when the suspension is homogeneous, and the mixing step completed. For example, the suspension can be considered fully mixed when there are no visible clumps of fibers and/or when there is no fiber material clinging to the side of the mixing container. Preferably, both parameters are met, i.e., no visible clumps of fibers and no fiber material clinging to the side of the mixing container. In some approaches, the mixing includes a combination of centrifugal mixing, such as by using a centrifugal mixer (e.g., a Thinky ARE-310 mixer offered by Thinky U.S.A., Inc. of Laguna Hills, CA), and application of an ultrasonic probe (e.g., an ultrasonic probe offered by Cole-Parmer of Vernon Hills, IL) to the suspension. In an example, the suspension is mixed using a centrifugal mixer, then an ultrasonic probe is applied, and then the suspension is again mixed using a centrifugal mixer. Still further, the ultrasonic probe can be applied in short bursts to avoid undesired heating of the mixture which could cause the binder to cure prematurely. In an example, the ultrasonic probe is applied to the mixture in pulses, alternating two (2) seconds ON and two (2) seconds OFF, over a two (2) minute period. Still further, magnetic bar mixing can be combined with the other mixing techniques described herein. It should further be appreciated that the temperature of the suspension can be controlled using a cool environment, such as an ice bath.

It should be appreciated that forming 534 and mixing 536 of the suspension can be completed in a series of alternating forming and mixing steps. In an example, PVA is dissolved in DI water using a centrifugal mixer, e.g., by mixing the combination for 10 minutes at 2000 rpm or longer if needed. If an additional dispersant is included, additional mixing can be performed, such as an additional 30 seconds at 2000 rpm. After the PVA, and additional dispersant, is dissolved, the solids (e.g., fibers and powders) can be added and mixed. As described above, the mixing can include alternating centrifugal mixing and application of an ultrasonic probe, such as by mixing for 30 seconds at 2000 rpm in the centrifugal mixer, using the ultrasonic probe for 2 minutes by pulsing 2 seconds on and 2 seconds off or longer if needed, and mixing for an additional 30 seconds at 2000 rpm. The mixing steps can be repeated as needed until achieving a homogeneous suspension.

Testing was performed to determine various combinations and orders of mixing techniques to provide flowable fiber composite materials. A sampling of the various combinations is shown in TABLE 2, which provides a summary for various first trials for each of the listed composite compositions.

TABLE 2

| Trial | Composition | Result |
|---|---|---|
| 1 | ZrB₂-5 wt % Si₃N₄, | Fibers survive spray, many |
| | 6 vol % solids loading, | fractured granules. Lot of |
| | 7 wt % PVA to solids | fiber clumps observed. |
| | Magnetic stir bar | |
| 2 | ZrB₂-10 wt % CNF, | Separation of CNF and ZrB₂ |
| | 9 vol % solids loading, | in slurry, not well mixed. |
| | 7 wt % PVA to solids | Fibers survive spray, fiber |
| | Thinky centrifugal | core and ZrB₂ shell |
| | mixing, magnetic stir bar | observed. Lot of fiber |
| | | clumps observed. |
| 3 | ZrB₂-7.5 wt % CNF, | Fibers survive spray, fiber |
| | 1:1 CNF to Triton X, | core and ZrB₂ shell |
| | 8 vol % solids loading, | observed. Some fiber |
| | 7 wt % PVA to solids | clumps observed. |
| | Thinky centrifugal | |
| | mixing, magnetic stir bar | |
| 4 | ZrB₂-7.5 wt % SiC, | Fibers survive spray, fiber |
| | 9 vol % solids loading, | core and ZrB₂ shell |
| | 7 wt % PVA to solids | observed. Fiber length >> |
| | Thinky centrifugal mixing, | granule diameter |
| | Ultrasonic probe 2 min, | |
| | (2 sec on, 2 sec off) | |
| | Magnetic stir bar during | |
| | spray dry | |

At step 538, the mixed suspension is spray dried. In particular, the mixed suspension is pumped into a spray dryer and the suspension is atomized in the presence of a drying gas to produce composite particles. In an example, a Buchi Mini Spray Dryer B-290 can be used to spray dry the mixed suspension. As an optional step, mixing of the suspension can continue during the spray drying step, such as by using a magnetic bar mixer in the suspension during the spray dry process, to prevent settling of the components of the suspension. It should be appreciated that selection of a particular combination of the viscosity of the suspension, nozzle size, gas flow and pump rate within the spray dryer can be used to alter the size of the resulting composite particles, as would be appreciated by one skilled in the art.

In some instances, it was found that after the spray drying step the resulting particles exhibited some dampness/tackiness, which could result in reduced flowability. At step 540, heat treatment, such as a burnout procedure, is applied to the composite particles to further burn out some, and preferably substantially all, of the remaining binder and to improve flowability. For example, heat treating the plurality of particles for performing burnout may include heating the plurality of particles for a predetermined period of time at a predetermined temperature sufficient to burn off a predetermined amount of the binder from the suspension that remains in the plurality of particles. Any suitable combination of temperature and heating time may be used during the burnout procedure to remove at least a predetermined amount of the binder, e.g., at least 90% of the binder, at least 95% of the binder, about 100% of the binder, etc., as would become apparent to one skilled in the art after reading the present disclosure. In an example, the spray dried fiber composite particles were held at 800° ° C. for three (3) hours in an inert environment, such as in an Argon gas environment, to burn out a PVA binder.

The final composition of the particles after burnout generally have about the same ratios of fiber component to particle component.

As an optional step, the flowability of the resulting fiber composite material can be characterized. The flowability can be determined to assure that a part or coating can be manufactured with the fiber composite material using desired manufacturing methods. For example, the Carr index and/or Hausner ratio of the resultant material can be determined by known methods to analyze whether the fiber composite material exhibits sufficient flowability. In some examples, the flowable fiber composite material is formulated to have a Carr index of less than 15. In some examples, the flowable fiber composite material is formulated to have a Carr index of less than 20. In some examples, the flowable fiber composite material is formulated to have a Carr index of less than 25. In some examples, the flowable fiber composite material is formulated to have a Hausner ratio of less than 1.25. Alternative methods of analyzing flowability can be used, such as by performing avalanche spectrum analysis using a revolution powder analyzer (e.g., a revolution powder analyzer offered by Mercury Scientific, Inc. of Newtown, CT).

The resulting fiber composite material can be characterized using a variety of techniques. For example, the material can be characterized using a scanning electron microscopy, X-ray diffraction analysis, optical microscopy, power-spectral density analysis, energy dispersive spectroscopy, etc. and combinations thereof.

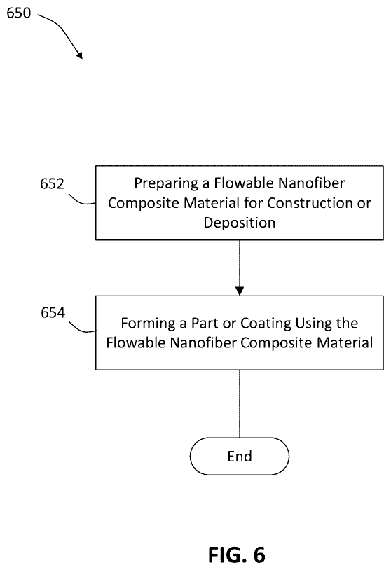

FIG. 6 depicts a flowchart 650 of an example of using a flowable fiber composite material according to an approach. The method of flowchart 650 can be used to produce a part or coating, including a thermal barrier coating, using the flowable fiber composite material. Further compositional, structural, and operational aspects will be apparent to persons skilled in the relevant art(s) based on the discussion regarding flowchart 650.

As shown in FIG. 6, the method of flowchart 650 begins at step 652. In step 652, a flowable fiber composite material is prepared for use in construction of a part, or for deposition to form a coating, e.g., a layer in a composite or laminated structure, an outer coating, a shell on another object, etc. The step of preparing a flowable fiber composite material includes configuring a flowable fiber composite material so that it can be used in a desired manufacturing process, such as by loading the material into an appropriate apparatus. In some examples, the flowable fiber composite material, such as any of the exemplary materials described herein, can be loaded into a plasma sprayer, or distributed to form a powder bed. Additionally, the step of preparing a flowable fiber composite material can include making a flowable fiber composite. As an example, the step of preparing a flowable fiber composite material can include the steps described with respect to FIGS. 5A and 5B and/or elsewhere herein.

At step 654, the flowable fiber composite material is used to form a part or coating. Any manufacturing method that utilizes a flowable particle feedstock can be used. For example, the flowable fiber composite material feedstock can be used in methods including plasma spray, spark plasma sintering, hot pressing, additive manufacturing methods such as direct ink writing, powder bed fusion methods, injection molding, extrusion, slip casting, gel casting, tape casting, etc. and combinations thereof.

Further steps may be performed on the formed product or coating to finalize fabrication of the product or coating, such as sintering, etc.

Referring to FIGS. 7A and 7B, an exemplary flowable fiber composite material 760 is illustrated at different magnifications. In the illustrated example, the flowable fiber composite material is constructed from a fiber component including 7.5 wt % SiC fibers 762 and a powder component including ZrB₂ powder 764. Additionally, the exemplary flowable fiber composite was created using PVA as a binder in the pre-sprayed suspension. As shown, while the fiber length is not optimized for the desired particle size, the composite material demonstrates a generally core-shell construction including the fibers 762 forming cores, or frameworks, with the powder 764 collecting to form roughly spherical shells around the fibers 762. The sample also demonstrates that the SiC fibers 762 are able to survive the spray drying process.

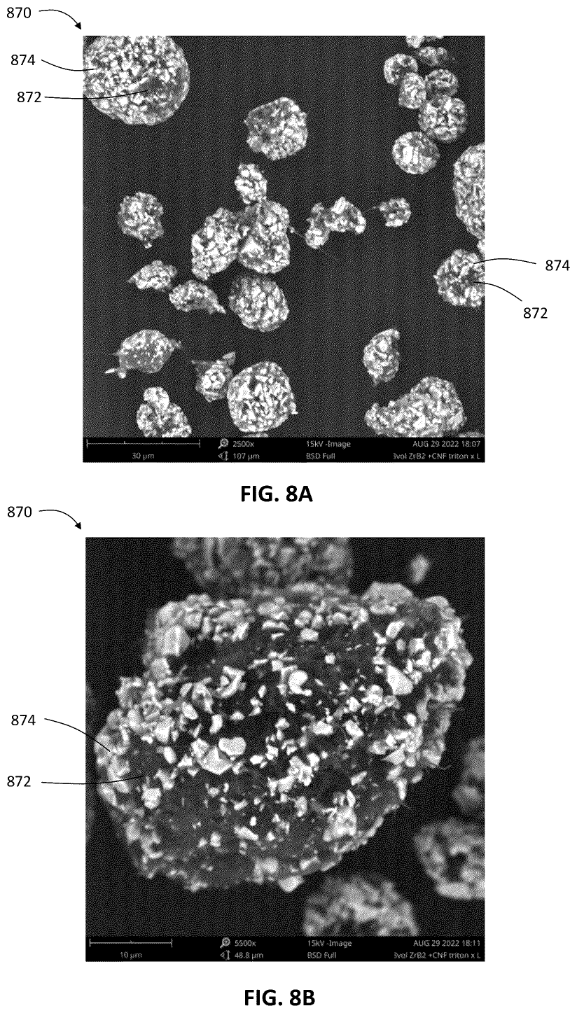

Referring to FIGS. 8A and 8B, another exemplary flowable fiber composite material 870 is illustrated at different magnifications. In the illustrated example, the flowable fiber composite material is constructed from a fiber component including 7.5 wt % carbon fibers 872 and a powder component including ZrB₂ powder 874. Additionally, the exemplary flowable fiber composite was created using PVA as a binder, and Triton X as a dispersant, in the pre-sprayed suspension. The dispersant was selected to be Triton X because it proved to function well with the carbon fibers to improve the dispersion of the carbon fibers in the pre-sprayed suspension. The images show that the exemplary fiber composite material formed a generally core-shell construction that includes the fibers 872 forming a core that is generally encrusted by a powder 874 shell. Again, some fibers 872 may protrude from the outer surface of the powder shell.

Also of note in FIGS. 8A and 8B is that an ultrasonic probe was not used. These FIGS. show that the process generally works well with the core shell structure, but there are still large clusters/clumps of fiber that were not broken up with centrifugal mixing and magnetic stir bar mixing alone.

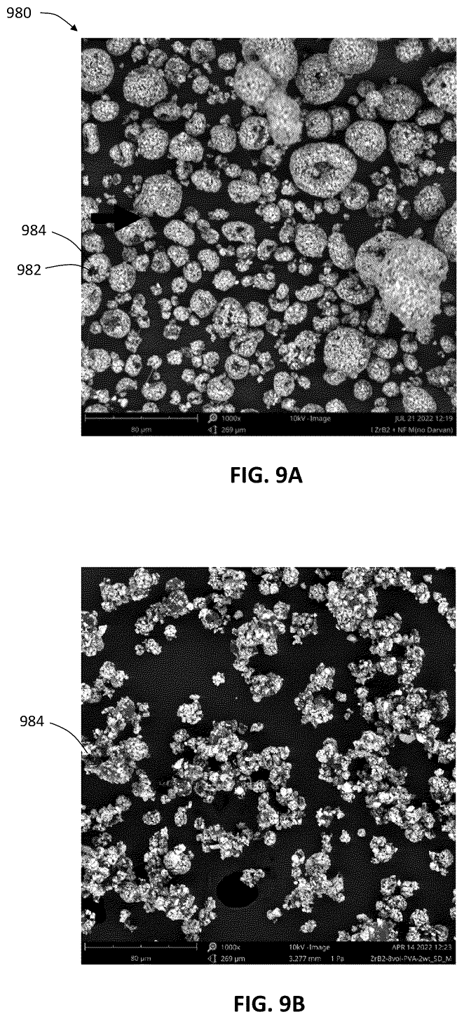

Referring to FIGS. 9A and 9B, a comparison between a fiber composite material 980, according to an approach, and a powder processed using a similar method is illustrated at the same magnification. In particular, FIG. 9A illustrates fiber composite material 980 that is constructed from a fiber component including 7.5 wt % Si₃N₄ fibers 982 and a powder component including ZrB₂ powder 984, such as produced using the methods described with regard to FIGS. 5A and 5B. For example, the fiber composite material 980 was constructed using a suspension having a composition of 8.5 vol % (ZrB₂+Si₃N₄ fibers), 7.5 wt % fibers, ˜7 wt % PVA relative to the total powder that is spray dried. FIG. 9B illustrates a spray dried material that is constructed from powder without fibers using a process similar to that described with regard to FIGS. 5A and 5B. In particular, the spray dried material was constructed using a composition of 8 vol % (ZrB₂), ˜7 wt % PVA relative to the powder, that is spray dried. The images show that the addition of fibers results in a fiber composite material 980 that generally forms spherical microparticles with a core-shell construction of a core of fibers with a shell of powder. On the other hand, the powder material shown in FIG. 9B includes particles having a wider variety of size and shape in comparison to the fiber composite material particles of FIG. 9A.

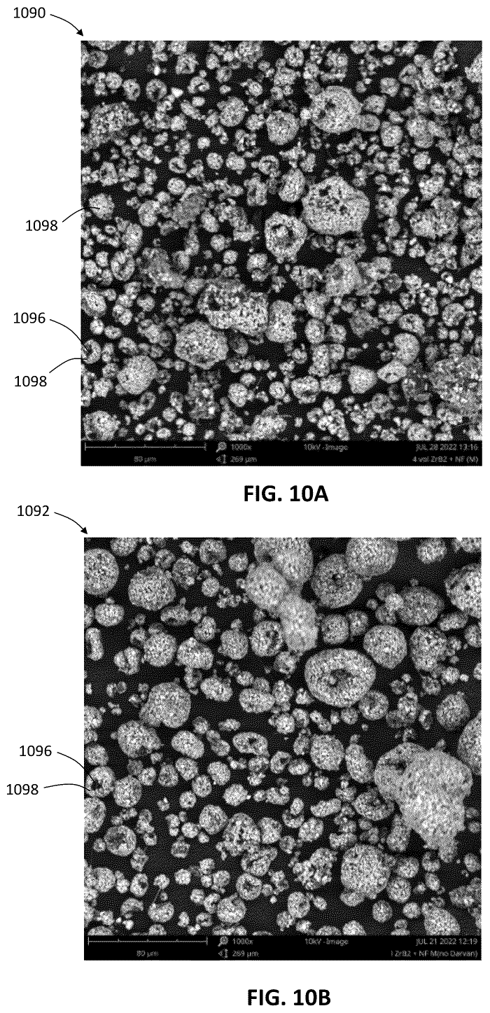

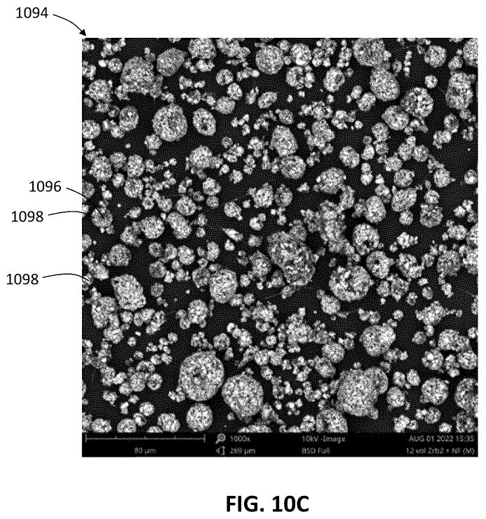

Referring to FIGS. 10A-C, exemplary flowable fiber composite materials 1090, 1092, and 1094 are illustrated at the same magnification. The images demonstrate differences in the flowable fiber composite material particle morphology resulting from different solids loading. All of the flowable fiber composite materials 1090, 1092, and 1094 were made using combinations of Si₃N₄ fibers 1096, ZrB₂ powder 1098, and a PVA binder. Flowable fiber composite material 1090 was constructed using a suspension having a composition of 4 vol % (ZrB₂+Si₃N₄ fibers), 7.5 wt % fibers, ˜7 wt % PVA relative to the total powder and fiber content. Flowable fiber composite material 1090 was constructed using a suspension having a composition of 8.5 vol % (ZrB₂+Si₃N₄ fibers), 7.5 wt % fibers, ˜7 wt % PVA relative to the total powder and fiber content. Flowable fiber composite material 1090 was constructed using a suspension having a composition of 12 vol % (ZrB₂+Si₃N₄ fibers), 7.5 wt % fibers, ˜7 wt % PVA relative to the total powder and fiber content. The images illustrate that the size and shape of the particles resulting from the methods of forming the materials described herein can be altered by varying the solids loading of the suspension that is subsequently spray dried.

The inventive concepts disclosed herein have been presented by way of example to illustrate the myriad features thereof in a plurality of illustrative scenarios, aspects, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

What is claimed is:

1. A fiber composite material, comprising:
a plurality of particles, each particle being a composite of at least one fiber component and at least one powder component.

2. The fiber composite material of claim 1, wherein the particles have a core-shell configuration, wherein the fiber component forms the core and the powder component forms the shell.

3. The fiber composite material of claim 1, wherein the plurality of particles has a flowability defined by a Carr index of less than 25.

4. The fiber composite material of claim 1, wherein the powder component is a ceramic material.

5. The fiber composite material of claim 4, wherein the fiber component is a second ceramic material.

6. The fiber composite material of claim 1, wherein one or more of the at least one fiber component is organic.

7. The fiber composite material of claim 1, wherein one or more of the at least one fiber component is inorganic.

8. The fiber composite material of claim 1, wherein a majority of the particles have equivalent size diameters that are on micron scale in a range of about 1-1000 μm.

9. The fiber composite material of claim 1, wherein the particles have an average equivalent size diameter of less than about 100 μm.

10. The fiber composite material of claim 1, wherein a volumetric ratio of the fiber component to the powder component is in a range of 0.01:10 to 10:1.

11. A method of making a flowable fiber composite material, the method comprising:
forming a suspension comprising at least one fiber component, at least one powder component, and a solvent;
mixing the suspension for dispersing the at least one fiber component throughout the suspension;
spray drying the suspension to form a plurality of particles, each particle including the at least one fiber component and the at least one powder component; and
heat treating the plurality of particles.

12. The method of claim 11, wherein the particles have a core-shell configuration, wherein the fiber component forms the core and the powder component forms the shell.

13. The method of claim 11, wherein mixing the suspension includes a combination of centrifugal mixing and application of an ultrasonic probe.

14. The method of claim 13, wherein the suspension includes a dispersant in an effective amount to enhance distribution of the fiber component throughout the suspension.

15. The method of claim 13, wherein the suspension includes a defoaming agent.

16. The method of claim 11, wherein heat treating the plurality of particles includes heating the plurality of particles for a predetermined period of time at a predetermined temperature sufficient to burn off a predetermined amount of a binder included in the suspension that remains in the plurality of particles.

17. A method of using a flowable fiber composite material, comprising:
preparing a flowable fiber composite material, wherein the flowable fiber composite material includes a plurality of particles having at least one fiber component and at least one powder component; and
forming a part or coating using the flowable fiber composite material.

18. The method of claim 17, wherein preparing the flowable fiber composite material includes configuring the flowable fiber composite material for at least one manufacturing method selected from the group consisting of: plasma spray, spark plasma sintering, hot pressing, direct ink writing, powder bed fusion, injection molding, extrusion, slip casting, gel casting, and tape casting.
